(19) United States
(12) Patent Application Publication
(10) Pub. No.: US 2011/0262224 A1
(43) Pub. Date: Oct. 27, 2011

(54) Attachment Mechanism

(76) Inventors: Benjamin McCandless, Pittsburgh, PA (US); Adam Hahn, Pittsburgh, PA (US)

(21) Appl. No.: 13/092,886

(22) Filed: Apr. 22, 2011

Related U.S. Application Data
(60) Provisional application No. 61/342,991, filed on Apr. 22, 2010.
(60) Provisional application No. 61/343,399, filed on Apr. 28, 2010.

(51) Int. Cl. F16B 17/00

(52) U.S. Cl. 403/376

(57) ABSTRACT

An attachment mechanism for mating components includes a receiving member having at least two slots therein, a base member having at least one protrusion positioned thereon and configured to be received in at least of one of the slots, a retaining member having at least two elongated protrusions each configured to engage at least one of the slots respectively.

### CROSS REFERENCE TO RELATED APPLICATION

This application claims the benefit of priority of U.S. Provisional Patent Application Ser. No. 61/342,991, filed Apr. 22, 2010, and U.S. Provisional Patent Application Ser. No. 61/343,399, filed on Apr. 28, 2010, on which this patent application is based and all of which are incorporated herein by reference in their entireties.

### FIELD OF THE DISCLOSURE

The present disclosure relates to a mechanism for rigidly and releasably positioning at least two parts in a manner that provides convenient assembly and disassembly.

### BACKGROUND

Although many methods and devices are available for standard engagement and attachment of two or more parts, such as, for example, threaded members in threaded apertures, none of those known do so in a small working envelope with quick release and engagement. Further, many other solutions are unable to provide a maintained stable and locked position such that decoupling and coupling may be accomplished. In addition, one or more of the above features may not be available in traditional attachment mechanisms to attach cylindrical parts and flat shaped parts. Such mechanisms include, for example, flared pipe fittings, threaded connections and Luer locks (e.g., to connect medical or laboratory instruments, including syringes, needles, etc.), snap fit connections (which rely on flexing of material in at least one part to grab onto other geometry of another part with which the flexing part is to be connected), retaining member and groove connections in which one part has a circumferential groove into which a retaining member (which may be spring-loaded) is driven (e.g., retaining member and groove fittings used during welding or tapping of drill pipes or pipe fittings for fluid-carrying metallic pipes), and collets.

### SUMMARY OF INVENTION

Therefore, it is an object of the present invention to provide two or more parts that may be joined in a manner to provide a temporary joint on an as-needed basis, yet the manner of joining those parts is precise, rigid, and repeatable.

Accordingly, in one embodiment, two concentric cylindrical parts may be removably attached to each other without sacrificing the firmness of the joint in the presence of axial forces, bending moments, or torques. In another embodiment, two plates may be may be removably attached to each other without sacrificing the firmness of the joint in the presence of axial forces, bending moments, or torques.

In another embodiment, the attachment mechanism is conducive to be used with gloved hands, thereby facilitating its use during surgery or other similar situations requiring hygienic conditions. The attachment mechanism according to one embodiment of the present disclosure requires minimum number of parts and occupies a small package space. Hence, the attachment mechanism adds very little additional volume to the volume already occupied by the cylindrical parts to be joined, thereby facilitating its use in situations where space or additional expansion of space is restricted. In one embodiment, the present attachment mechanism provides for locking of parts with a clearly perceptible action.

In another embodiment, the present invention provides an attachment mechanism that includes a receiving member, a base member and a retaining member. The receiving member has at least two slots therein, the base member has at least two protrusions positioned thereon and the retaining member has at least two elongated protrusions thereon. The base member may further be configured to be received in at least of one of the slots of the receiving member and the retaining member has at least two elongated protrusions, wherein each is configured to engage at least one of the slots respectively.

It is noted at the outset that the mechanical structures, components, assemblies, or engineering drawings or planar views thereof illustrated in various figures in the instant application are not drawn to scale, but are rather illustrated for the convenience of understanding various design aspects of a cylindrical-parts attachment mechanism according to the teachings of the present disclosure.

These and other features and characteristics of the present invention, as well as the methods of operation and functions of the related elements of structures and combinations of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended to unduly limit the present invention. As used in the specification and the claims, the singular form of “a”, “an”, and “the” include plural referents unless the context clearly dictates otherwise.

### BRIEF DESCRIPTION OF DRAWINGS

FIG. 1 is an exploded perspective view of an embodiment of an attachment mechanism in accordance with the present invention;

FIG. 2 is an assembled perspective view of an of the attachment mechanism shown in FIG. 1 in accordance with the present invention;

FIG. 3A is a top view of one embodiment an attachment mechanism of FIG. 1 in accordance with the present invention;

FIG. 3B is an end view of one embodiment of an attachment mechanism of FIG. 3A in accordance with the present invention;

FIG. 3C is a cross-sectional view of one embodiment of an attachment mechanism of FIG. 3A, B, taken about line A-A, in accordance with the present invention;

FIG. 4 is a top view of a one embodiment of a protrusion in accordance with the present invention;

FIG. 5 is a perspective view of an embodiment of an receiving member in accordance with the present invention;

FIG. 6A is a top view of one embodiment of an receiving member in accordance with the present invention;

FIG. 6B is a rear view of the receiving member of FIG. 6A in accordance with the present invention;

FIG. 6C is an end view of an receiving member of FIG. 6A in accordance with the present invention;

FIG. 7 is a plan view of an embodiment of an receiving member in accordance with the present invention;

FIG. 8 is a perspective view of an embodiment of a base in accordance with the present invention;

FIG. 9A is a top view of one embodiment of a base in accordance with the present invention;

FIG. 9B is a side view of the base of FIG. 6A in accordance with the present invention;

FIG. 9C is an end view of base of FIG. 6A in accordance with the present invention;

FIG. 10A is a top plan view of an embodiment of a base in accordance with the present invention;

FIG. 10B is a side view of the base of FIG. 10A in accordance with the present invention;

FIG. 10C is a side view of the base of FIG. 10A in accordance with the present invention;

FIG. 11 is a perspective view of one embodiment of a retaining member in accordance with the present invention;

FIG. 12A is a top plan view of an embodiment of a retaining member in accordance with the present invention;

FIG. 12B is a side view of the retaining member of FIG. 12A in accordance with the present invention;

FIG. 12C is an end view of the base of FIG. 12A in accordance with the present invention;

13A is a top plan view of one embodiment of an attachment mechanism in accordance with the present invention;

FIG. 13B is a side view of the attachment mechanism of FIG. 13A in accordance with the present invention;

FIG. 13C is a cross-sectional view of the attachment mechanism of FIGS. 13A, B, along line C-C in accordance with the present invention; and

FIG. 14 is an exploded perspective view of an attachment mechanism in accordance with the present invention.

### DETAILED DESCRIPTION OF THE PRESENT INVENTION

For purposes of the description hereinafter, the terms “upper”, “lower”, “right”, “left”, “vertical”, “horizontal”, “top”, “bottom”, “lateral”, “longitudinal” and related derivatives thereof shall relate to the invention as it is oriented in the drawing figures. However, it is to be understood that the present invention may assume various alternative variations and step sequences, except where expressly specified to the contrary. it is also to be understood that the specific devices and processes illustrated in the attached drawings, and described in the following specification, are simply exemplary embodiments of the invention. Hence, specific dimensions and other physical characteristics related to the embodiments disclosed herein are not to be considered as unduly limiting.

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

FIG. 1 illustrates a receiving member 10 and base 12 that may be concentric, in one embodiment, and may further be joined using a cylindrical retaining member 14 according to one embodiment of the present invention. The receiving member 10 and base member 12 may be releasably locked within retaining member 14 as discussed herein further below. Additional locking support for the attachment mechanism generally may be provided using a pin 16 to constrain rotational movement of the retaining member 14. In one embodiment, the retaining member 14 may be spring-loaded onto the base 12 for additional tightening of the joint.

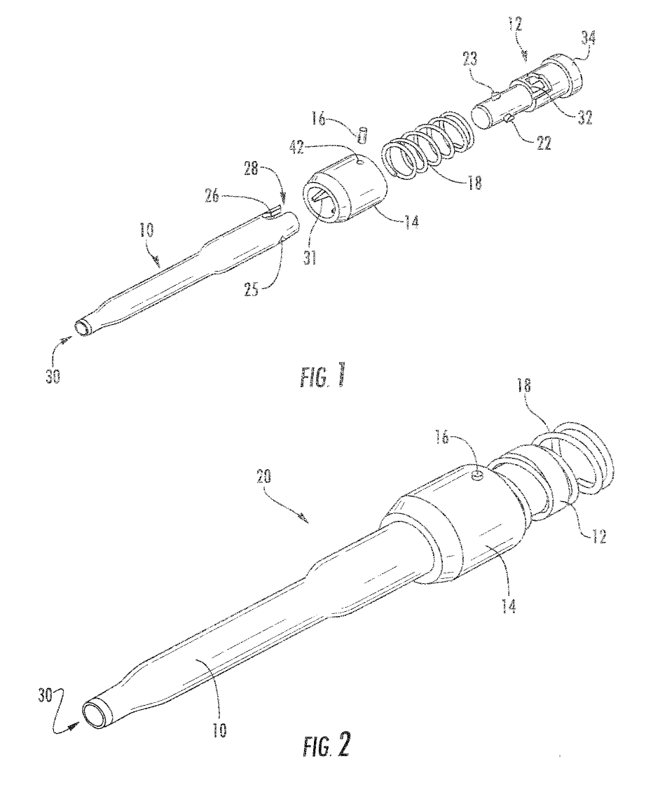

FIG. 2 shows a fully-assembled attachment mechanism 20 that results when the cylindrical parts 10, 12 illustrated in FIG. 1 are attached using the retaining member 14 having elongated protrusions 31. In one embodiment, specially-shaped protrusions 22, 23 on the base 12 are shown in FIG. 1 and may be first engaged with one or more slots 25, 26 having a corresponding geometry. Protrusions 22, 23 may thus pass elongated slots 31 into end 28 on the receiving member 10. Once the receiving member 10 is thus moved into its final position with reference to the base 12, the retaining member 14, which may be optionally loaded with the spring 18 may be axially disposed towards the receiving member 10 and slid over the receiving member 10 from the non-slotted, “front” end 30 of the receiving member 10 to lock the base member 12 against the receiving member 10.

Retaining member 14 may prevent the receiving member 10 from moving out of a desired position due to it designed geometry. For example, the retaining member 14 may have two or more elongate protrusions 31 visible in FIG. 1 that get inserted into the corresponding slots 25, 26, on the receiving member 10 when the retaining member 14 is slid over the receiving member 10 and axially moved towards the base 12. The spring 18 may further maintain insertion of elongate protrusions 31 into the slots 25, 26 of the receiving member 10.

According to one embodiment of the present invention, a specially-shaped slot 32 may be provided on the base 12 to allow pin 16 to slide inside the slot 32 and assume a locking position when the retaining member 14 is rotated slightly. Thus, the pin 16, when inserted and locked into the slot 32 through an aperture 42, may constrain the retaining member 14 rotation about a central axis of the base 12 and the retaining member 14 translation along the central axis of the base 12. Additional constructional details of the receiving member 10, base 12, and retaining member 14 is provided hereinbelow.

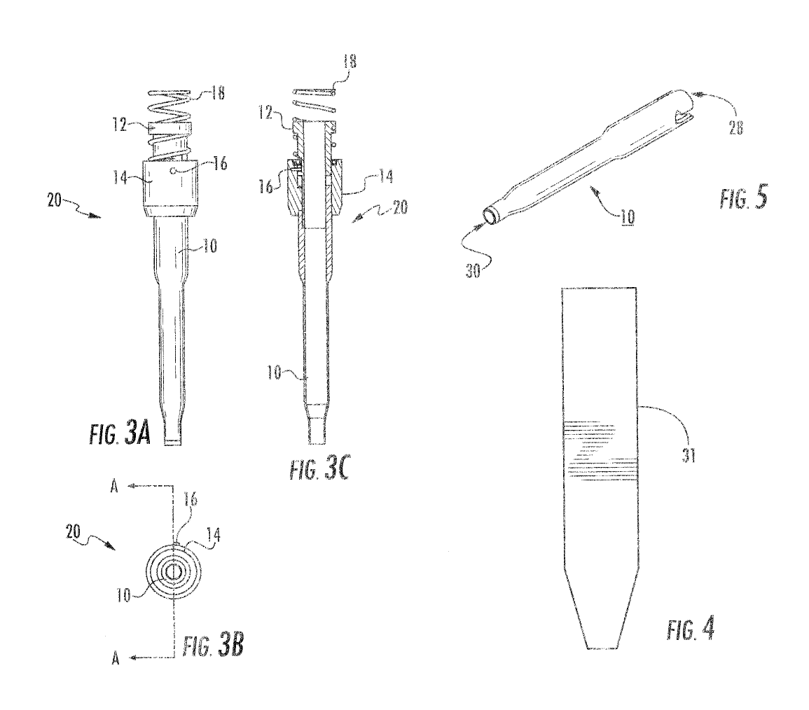

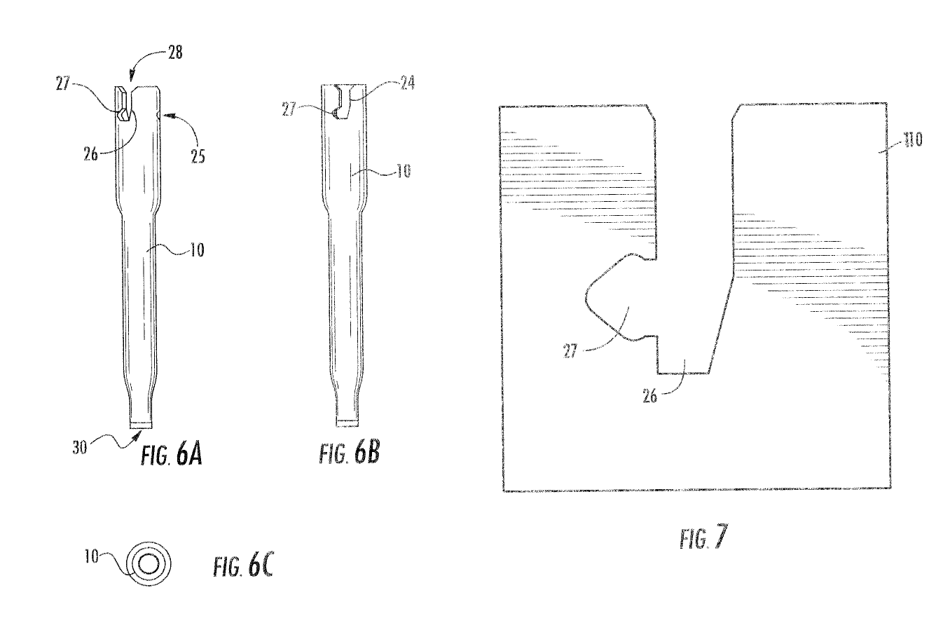

FIG. 3A depicts an assembled attachment mechanism 20 similar to FIG. 2, but from a plan view. FIG. 3B is an end view and FIG. 3C a cross-section about line C-C in FIG. 3B showing the internal engagement of the receiving member 10, base member 12, and retaining member 14. Accordingly, two or more base member 12 protrusions 22, 23 have been slid into two or more retaining member 14 slots 25, 26 as illustrated in FIGS. 6A-6C. Then receiving member 10 is then secured/locked in place when elongated protrusions 31 engage the slots 25, 26 preventing removal of protrusions 22, 23 in an assembled state.

FIG. 4 shows a planar view of an elongate protrusion 31 that may protrude above an inner surface of the retaining member 14 such as, for example, the cylindrical inner surface of retaining member 14. Additional details of engagement of the retaining member 14 against the receiving member 10 are provided hereinbelow with reference to discussion of FIGS. 13A-13C.

FIGS. 5 and 6A-6C illustrate the receiving member 10 that may be engaged from the end 28 by base member 12. According to one embodiment of the present disclosure. FIG. 6A shows a front view, FIG. 6B shows a rear view, and FIG. 6C shows an end view of the receiving member 10. The concentric cylindrical geometry of the receiving member 10 is apparent from the front view of FIG. 6A. Although two slots 25, 26 are shown in FIG. 6A, in one embodiment, there may be three or more such slots, including slot 24 in FIG. 6B for example. Accordingly, slots 24, 25, 26 on the receiving member 10 may first receive two or more corresponding protrusions 22, 23 of the base member 12. The protrusions 22, 23 on the base member 12 may thus lock against within two or more slots 25, 26 on the receiving member 10, allowing a repeatable and releasable fit.

A slightly slanted protuberance (e.g., the protuberance 27 visible in FIG. 6A) in each slot on the receiving member 10 may be shaped to accommodate corresponding protrusion of the base member 12 so as to assist in locking the protrusions on the base member 12. It is noted here that these protuberances may have many different shapes, and their slants may vary as well (or may be entirely missing) in different embodiments.

A planar view in FIG. 7 illustrates additional geometrical details of slot 26 and its protuberance 27 on a receiving member 110. Such a slot 26, may be employed I a variety of configurations such as receiving member 10 in a cylindrical configuration or in a planar configuration on receiving member 110 as discussed in great detail hereinbelow. FIG. 7 illustrates how protrusions may be configured to travel down slot 26 and lock into protuberance 27 when elongate protuberance 31 is also position in slot 26 while protrusion 22 is positioned in protuberance 27.

It is observed here that although a three-slot embodiment for the receiving member 10 is discussed herein, in various embodiments, there may be any number of such slots so long as there is sufficient material to accommodate them. Additionally, these slots may be spaced in such a way that the parts can be attached in specific orientations. For example, an evenly-spaced arrangement of slots allows the parts to be assembled in as many orientations as slots. However, carefully altering the spacing may reduce the possible orientations to some smaller number, or even to a unique orientation. Similarly, the base 12 also may have any number of protrusions, up to the number of the slots on the receiving member 10.

FIG. 8 illustrates a close-up perspective view of the base 12 according to one embodiment of the present invention. In one embodiment, the base 12 may have external protrusions 21, 22, 23 to lock against corresponding slots 24, 25, 26 on the receiving member 10, as discussed further herein. As noted before, the base 12 may have any number of protrusions, up to the number of the slots on the receiving member 10.

In one embodiment, the base 12 may have its own slot 32 to receive an external pin 16 that may be inserted into the slot 32 through the aperture 42 on the retaining member 14 to form a locking fit for the retaining member 14. Once the pin 16 is inserted into the slot 32, the retaining member 14 may be initially slightly moved axially along the slot 32 while compressing the spring 18, and then the retaining member 14 may be slightly twisted or rotated counterclockwise to allow the pin 16 to assume a locking position inside the slot 32, so as to accomplish a locking fit between the retaining member 14 and the base 12.

The spring 18 may provide additional locking pressure against the movement of the pin 16 inside the slot 32. In one embodiment, the slot 32 may be located between the corresponding pair of protrusions 22, 23. The base member 12 may have an end portion 34 or other geometry suitable for integration with other parts, or for holding the base member 12 during assembly operations.

It is observed here that, in one embodiment, the external protrusions 21, 22, 23 on the base member 12 may have been configured to effectively engage protuberance 27 on a front side 23F of protrusion 23. Accordingly, the protrusion 23 surfaces of the base member 12 that contact the slots 26, 27 of receiving member 10 are configured to locate a locking geometry on the receiving member 10, thereby allowing a repeatable and releasable fit. In addition, a “back” side 23B of the protrusion 23 may be provided surfaces that may contact the elongated protrusion 31 of retaining member 14. Thus, these protrusions 21, 22, 23 provide a locking surface on the back side 23B against which the elongate protrusions 31 may slide against in two or more slots 24, 25, 26 to provide a locking fit with the receiving member 10. FIGS. 13A-13C (discussed below) provides details of such locking engagements.

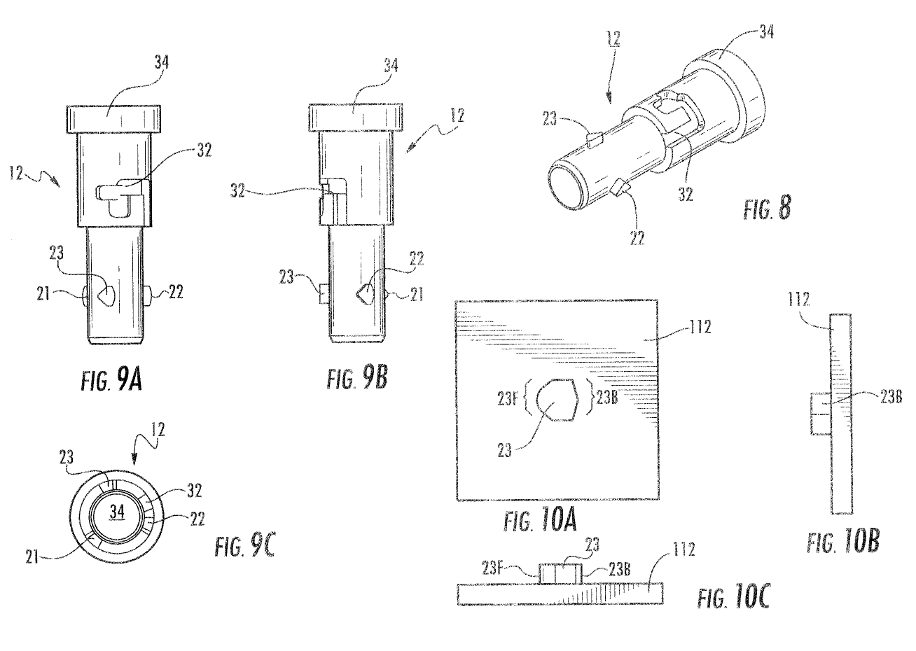

FIGS. 9A-9C depict three additional views of the base 12 geometry according to one embodiment of the present disclosure. FIG. 9A shows a front view, FIG. 9B shows a side view, and FIG. 9C shows an end view of the base 12. The three protrusions on the base 12 are more readily visible in the front and side views in FIGS. 9A-9B. The concentric cylindrical geometry of the base 12 is apparent from the end view of FIG. 9C.

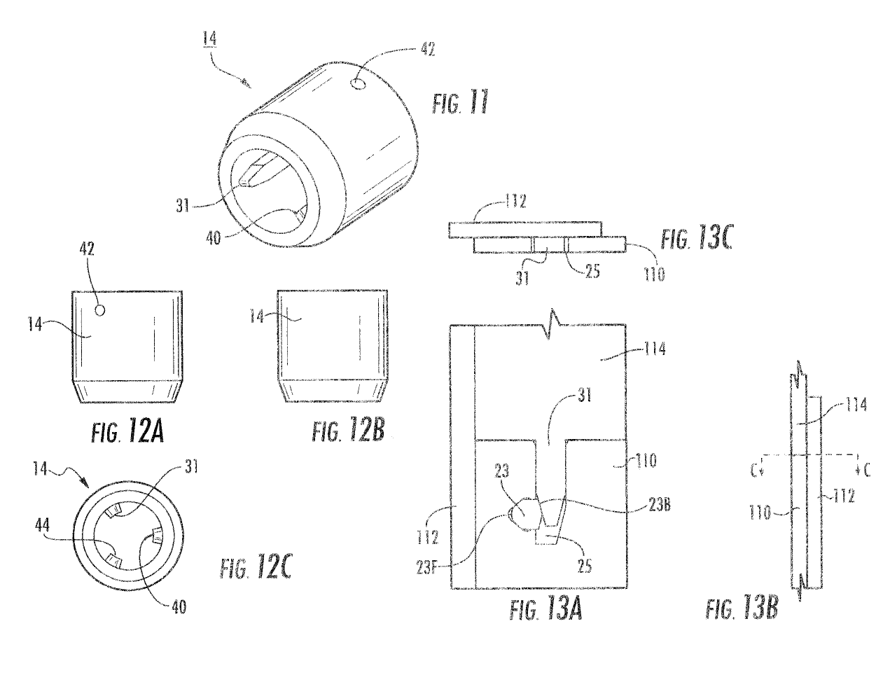

FIG. 10A shows a top plan view of a base 112 which may have two or more protrusions. The geometry of one of protrusions 23 is more clearly visible in FIG. 10A, having front 23F and back 23B configurations. It is observed here that the geometry of the protrusions 21, 22, 23 on the base 12 may match with the geometry of slanted protuberances 27, shown in FIGS. 6A and 7, on each slot 24, 25, 26 on the receiving member 10 so as to provide a locking fit inside that respective slot 24, 25, 26. FIGS. 10B and 10C show different side views shown on flat stock of that protrusion-containing portion of the base to illustrate how the three protrusions may be oriented in the base 112.

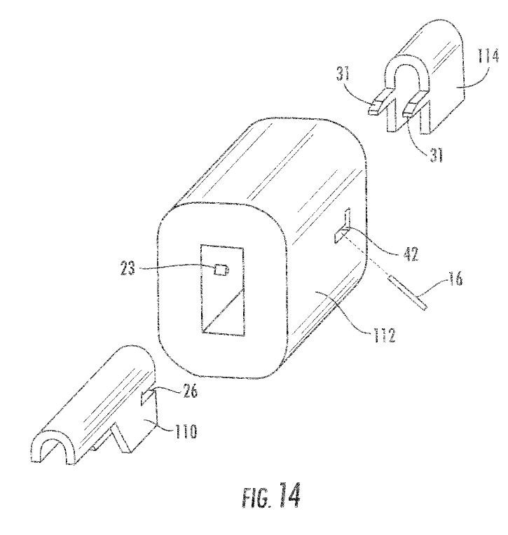

FIG. 11 illustrates a close-up perspective view of the retaining member 14 according to one embodiment of the present invention in a cylindrical configuration. In one embodiment, the retaining member 14 may have three internal elongate protrusions 31, 40, 44, as shown in FIG. 12C, two of which are visible in the perspective view of FIG. 11. As mentioned before, these elongate protrusions 31, 40, 44, may lock against corresponding slots 24, 25, 26 on the receiving member 10, 110.

The aperture 42 on the retaining member 14 surface may be provided to receive the pin 16. It is noted here that the retaining member 14 rotation around the axis of the base 12 and the retaining member 14 translation along the axis of the base 12 can be constrained when the pin 16 is inserted in the aperture 42 and lockingly engaged inside the slot 32 on the base 12 as mentioned before. This pin-in-the-slot arrangement may form an auto-locking mechanism, which can ensure that the retaining member 14 remains in an ideal (locked) position during use, thereby also maintaining the attachment between the receiving member 10 and the base 12 in locked alignment. Furthermore, the pin 16 can also act to retain the retaining member 14, ensuring that the retaining member does not fall off at inopportune moments.

FIGS. 12A-12C depict three additional views of the retaining member 114 according to one embodiment of the present invention. FIG. 12A shows a top view, FIG. 12B shows a side view, and FIG. 12C shows a front view of the retaining member 114 illustrated in FIG. 14. The elongate protrusions 31 of the retaining member 114 are more readily visible in FIG. 14.

In one embodiment, the elongate protrusions 31 may be slightly curved inwardly as illustrated in FIGS. 4 and 12C. It is observed here that the inner diameter of the base 12, containing protrusions 22-23, may be slightly smaller than the diameter of inner cylindrical surfaces of retaining member 14. When a cylindrical attachment mechanism 20 employs elongate protrusions 31, 40, 44, thereby allowing the retaining member 14 to slide over the base 12 without friction, such configuration is beneficial.

It is observed here that, in alternative embodiments, different shapes or configurations may be provided for the retaining member 14 elongate protrusions 31, so long as retaining member 14 axial or rotational movement over the base 12 is not restricted. The concentric cylindrical geometry of the retaining member 14 is also apparent from the front view of FIG. 12C.

FIG. 13A is an exemplary planar view illustrating how an elongate protrusion 31 on the retaining member 114 as well an external protrusion 23 on the base 112 may both engage inside a slot 25 on the receiving member 110 to form locking surfaces for rigid attachment of the receiving member 110 with the base 112 using the retaining member 114. FIG. 14 illustrates how such an arrangement might be implemented. FIG. 13A shows only a portion of the assembly just to illustrate the fitting of the base 110 and retaining member 114 into the receiving member 112. As mentioned before, after the base 112 is fitted into the receiving member 110, the retaining member 114 (along with the spring 18 in some embodiments) may be axially moved over the receiving member 110 towards the base 112, and the elongate protrusions 31 of the retaining member 114 may partially (or completely) get positioned inside the corresponding slots 25 on the receiving member 110 during retaining member 114 movement over the receiving member 110.

In a cylindrical embodiment, for example, the spring 18 may provide additional compressive force to maintain retaining member 114 elongate protrusions 31, 40, 44 well-positioned inside two or more slots 24, 25, 26 on the receiving member 10. Thus, simple sliding and rotational movements of the retaining member 1114 are all that is needed to accomplish locking of the cylindrical receiving member 110 and base 112.

FIGS. 13B and 13C provide additional planar and cross-sectional views showing alignment and orientation of the base 112 and receiving member 110 when the retaining member 114 is attached to the receiving member 110 in the manner illustrated in FIG. 13A.

FIG. 14 illustrates how FIGS. 13A-13C may be employed. Accordingly, the receiving member 110 may have one or slots 26 to engage one or more protrusions 23 on the base member 112. Retaining member 114 may further engage one or more slots 26 on receiving member 110 after being positioned on one or more protrusions 23 to lock the apparatus in place. To finally secure the engagement the pin 16 may be positioned through aperture 42 and engage retaining member 114.

It is noted here that various cylindrical parts depicted herein are for illustration purpose only. In different embodiments, such parts may have different geometry or shapes, and may be made of various types of materials (e.g., plastic, metal, etc.). However, the attachment mechanism and retaining member design may follow the design principles outlined herein. Furthermore, in one embodiment, the spring 18 may be fabricated as a built-in part of the retaining member 14, instead of a separate part illustrated in FIG. 1. Similar other configurations for other parts or the entire attachment mechanism 20 (FIG. 2) may be devised as per design considerations or intended applications. For example, in one embodiment, the receiving member 10, the base 12, and the retaining member 14 may form part of a surgical tool (e.g., the handheld PFS™ tool designed and marketed by Blue Belt Technologies™ of Pittsburgh, Pa., for bone cutting applications.

It is observed from the foregoing that the retaining member-based attachment mechanism allows concentric cylindrical parts to be rigidly attached in a compact manner. The attachment mechanism may lock the parts into unique, predefined position relative to one another, while requiring only a slight twist (as compared to threaded connections) to accomplish a locking fit between the parts. The attachment mechanism does not rely on elastic behavior of the materials to form a close fit between the parts and other ancillary components. Furthermore, although the retaining member is described herein with the locking geometry on the inside of the retaining member, in an alternative embodiment, such locking geometry may be outside of the retaining member (i.e., the retaining member may look like a ring with locking geometry protruding from one end). in such an alternative embodiment, the outer diameter of the retaining member would be smaller than the outer diameter of the receiving member.

Although the invention has been described in detail for the purpose of illustration based on what is currently considered to be the most practical and preferred embodiment(s), it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment. Since other modifications and changes varied to fit particular operating requirements and environments will be apparent to those skilled in the art, the invention is not considered limited to the example chosen for purposes of disclosure, and covers all changes and modifications which do not constitute departures from the spirit and scope of this invention.

What is claimed is:

1. An attachment mechanism, comprising:
a receiving member having at least two slots therein;
a base member having at least two protrusion positioned thereon and configured to be received in at least of one of said slots; and
a retaining member having at least two elongated protrusions each configured to engage at least one of said slots respectively.

2. The attachment mechanism of claim 1, wherein said receiving member forms a first cylindrical surface having a first diameter and said base member forms a second cylindrical surface having a second diameter, wherein said first diameter is greater than said second diameter.

3. The attachment mechanism of claim 1, wherein said retaining member forms a third cylindrical surface having a third diameter, wherein said first diameter is less than said third diameter.

4. The attachment mechanism of claim 1, wherein said receiving member and said retaining member have a substantially planar construction about said slots and said elongated protrusions.

5. The attachment mechanism of claim 1, wherein the base member further comprises at least one slot.

6. The attachment mechanism of claim 1, further comprising a locking pin for engaging said slot of said base member for securing said attachment mechanism.

7. The attachment mechanism of claim 1, wherein said attachment mechanism has conductive properties.

8. The attachment mechanism of claim 1, further comprising a biasing force to maintain said at least two elongated protrusions in said at least two slots.

9. The attachment mechanism of claim 1, wherein each said two or more slots may further comprise a protuberance adjacent to said respective slot.

10. The attachment mechanism of claim 9, wherein each of said two or more protrusions may be configured on one side to closely abut said respective protuberance.

11. The attachment mechanism of claim 1, wherein each of said two or more protrusions may be configured on a second side to closely abut said two or more elongated protrusions.

12. An attachment mechanism, comprising:
a base member;
a receiving member configured to engage at least a portion of said base member; and
a retaining member configured to engage said receiving member and said base member and prevent said retaining member and said base member from disengagement.

13. The attachment mechanism of claim 12, wherein said retaining member surrounds at least a portion of said base member and said receiving member.

14. The attachment mechanism of claim 12, wherein said base member surrounds at least a portion of said receiving member and said retaining member.

15. The attachment mechanism of claim 12, further comprising a pin configured to retain said retaining member from disengagement.
